(19) United States
(12) Patent Application Publication
(10) Pub. No.: US 2010/0189919 A1
(43) Pub. Date: Jul. 29, 2010

(54) Imaging System And Process Using Monoclonal Antibodies

(75) Inventor: Aillil Ian Halsema, Los Angeles, CA (US)

Correspondence Address: MARYLOU J. LAVOIE, ESQ. LLC, 1 BANKS ROAD, SIMSBURY, CT, 06070, US

(73) Assignee: Xerox Corporation, Norwalk, CT (US)

(21) Appl. No.: 12/360,128

(22) Filed: Jan. 27, 2009

(51) Int. Cl. B05D 3/06; B05C 11/00

(52) U.S. Cl. 427/553; 118/620

(57) ABSTRACT

An imaging system including a substrate; a monoclonal antibody coated on at least a portion of the substrate; at least one antigen dye that will bind to the monoclonal antibody coated portion of the receiving substrate upon exposure to light; wherein an image projected onto the monoclonal antibody coated substrate is recorded in the antigen dye particles that bind to the monoclonal antibody coated portion of the substrate.

### BACKGROUND

The present disclosure relates generally to imaging members for electrophotography. Specifically, the disclosure teaches an imaging system and process employing monoclonal antibodies and matching light-activated antigens, such as rhodopsin antigens, to record photographic images.

In electrophotography, an electrophotographic substrate containing a photoconductive insulating layer on a conductive layer is imaged by first uniformly electrostatically charging a surface of the substrate. The substrate is then exposed to a pattern of activating electromagnetic radiation, such as, for example, light. The light or other electromagnetic radiation selectively dissipates the charge in illuminated areas of the photoconductive insulating layer while leaving behind an electrostatic latent image in non-illuminated areas of the photoconductive insulating layer. This electrostatic latent image is then developed to form a visible image by depositing finely divided electroscopic marking particles on the surface of the photoconductive insulating layer. The resulting visible image is then transferred from the electrophotographic substrate to a member, such as, for example, an intermediate transfer member or a print substrate, such as paper. This image developing process can be repeated as many times as necessary with reusable photoconductive insulating layers.

Electrophotographic imaging members (i.e. photoreceptors) are well known. Electrophotographic imaging members are commonly used in electrophotographic (xerographic) processes having either a flexible belt or a rigid drum configuration. These electrophotographic imaging members sometimes comprise a photoconductive layer including a single layer or composite layers. These electrophotographic imaging members take many different forms. For example, layered photoresponsive imaging members are known in the art. U.S. Pat. No. 4,265,990, which is totally incorporated by reference herein, describes a layered photoreceptor having separate photogenerating and charge transport layers.

Photoconductive photoreceptors containing highly specialized component layers are also known. For example, a multilayered photoreceptor employed in electrophotographic imaging systems sometimes includes one or more of a substrate, an undercoating layer, an intermediate layer, an optional hole or charge blocking layer, a charge generating layer (including a photogenerating material in a binder) over an undercoating layer and/or a blocking layer, and a charge transport layer (including a charge transport material in a binder). Additional layers such as one or more overcoat layers are also sometimes included.

Photoimaging is performed using photoconductive substrates such as selenium, or photoactive chemicals such as silver halide. These materials are suitable for their intended purposes. However, currently available photoconductive substrate materials can be expensive, or can require expensive processing, or both. Further, the resolution attainable using currently available materials can be limited. Increases in resolution are increasingly expensive to attain. In addition, toners used with current photoconductive substrates often have their profitability limited because competitors sell third-party toners (sometimes referred to as “cloner toners”) for use in machines employing the current photoconductive substrates.

The color demands of images to be rendered by a marking device, such as a copier or printer, are usually specified in a device independent color space as part of a page description language (PDL). Color spaces typically used in PDL files include REG (red, green, blue additive color model), CMYK (cyan, magenta, yellow, key (black) subtractive color model used in color printing), Pantone, Inc. PANTONE color matching system, and L*a*b*. L*a*b* are the independent space representations of the CIE (Commission Internationale de L'eclairage) for color standards which are often utilized in the functional modeling of these color. L* defines lightness, a* correspondence to the red/green value and b* denotes the amount of yellow/blue. The PDL source color representations are transformed into representations which the device can reproduce with available colorants, such as cyan, magenta, yellow and black representations. A lookup table is used to determine which combination of available colorants, typically CMYK, will yield the desired colors specified.

Different color devices have different color capabilities. Every color device has a color gamut, that is, a range of colors that it can capture, produce, or display. Various attempts have been made to expand the color gamut of marking devices, such as to allow a closer match with the rendering of an image or to produce colors to meet specific customer requests, for example by producing custom colors. Often the colors which tend to be outside a given device's color gamut are those colors which have a high intensity of two or more of the colorants. In inkjet printing systems and offset lithography, spot color or high fidelity color printing has been developed in which conventional CMYK inks are augmented with additional primary colors beyond the usual four primary colors used to produce the process color output. These additional inks are used for extending the color gamut of the process color output to achieve high fidelity color and thereby more closely emulate standardized spot colors such as those define by Pantone. However, additional hardware is needed in the form of printing units.

U.S. Pat. No. 7,305,200, which is hereby incorporated by reference herein in its entirety, describes a printing system including a marking which applies colorants to a print medium to render an image. The marking engine has a single pass color gamut which the marking engine is capable of rendering in a single pass of the print medium through the marking engine. The marking engine is capable of rendering an extended color gamut in a plurality of passes of the print medium through the marking engine.

While known compositions and processes are suitable for their intended purposes, a need remains for improved imaging systems which exhibit improved image quality and robustness, that is resistance to scratch, crease and abrasion with substantially no smear, and image permanence. There is further a need for improved imaging systems and processes which provide improved ranges of color gamut. There further remains a need in the art for new cost effective imaging systems that can provide improved image resolution. There is a further need for improved imaging systems that do not require expensive processing. There is a further need for imaging systems that are not subject to reduced profitability via cloning by competitors.

The appropriate components and process aspects of the each of the foregoing may be selected for the present disclosure in embodiments thereof.

### SUMMARY

The present disclosure is directed to an imaging system comprising a substrate; a hydrophilic monoclonal antibody coated on at least a portion of the substrate; at least one antigen dye that will bind to the monoclonal antibody coated portion of the receiving substrate upon exposure to light; wherein an image projected onto the monoclonal antibody coated substrate is recorded in the antigen dye particles that bind to the monoclonal antibody coated portion of the substrate. In embodiments, the monoclonal antibodies are proteins known as Nanobodies™. In further embodiments, the antigen dye is rhodopsin.

Further disclosed is a process comprising projecting an image onto a substrate coated with hydrophilic monoclonal antibodies, in embodiments Nanobodies™, on at least a portion thereof; and recording the projected image in antigen dye particles that bind to the antibodies coating the substrate.

Further disclosed is an imaging process comprising projecting an image onto a positively charged substrate having exposed hydrophilic monoclonal antibodies disposed on at least a portion of the substrate; disposing at least one antigen dye thereover such that the antigen dye binds to the exposed portion of the antibody-coated substrate thereby recording the projected image via antigen dye particles bound to the exposed antibodies. In embodiments, the process includes providing an image transparency comprising one or more opaque portions and one or more transparent portions defining the image; and exposing the antibody-coated substrate to light thereby recording an image comprising the transparent portions of the transparency.

Advantages herein include a system and method for imaging using inexpensive monoclonal antibodies and matching antigens. In embodiments, the system and process uses inexpensive proteins smaller than the wavelength of blue light to provide low cost and high photographic resolution.

### BRIEF DESCRIPTION OF THE DRAWINGS

FIG. 1 is a graph illustrating normalised absorbance (y-axis) versus wavelength (x-axis, nanometers) for various light sensitive proteins.

FIG. 2 is a schematic depiction showing production of monoclonal antibodies by genetically modified bacteria and yeasts followed by purification of antibodies.

FIG. 3 is a schematic depiction showing an anti-body coated substrate exposed to light in the presence of an antigen dye.

### DETAILED DESCRIPTION

Monospecific antibodies are antibodies that have affinity for the same antigen. Monoclonal antibodies are monospecific antibodies that are identical because they are produced by one type of immune cell that are all clones of a single parent cell. Monoclonal antibodies can be created that will bind with specificity to almost any substance and can be used to detect or purify that substance. Monoclonal antibodies are used in biochemistry, molecular biology, and medicine, such as in medical diagnostic imaging. Traditional therapeutic monoclonal antibodies must be stored at near freezing temperatures to prevent their destruction. Monoclonal antibody proteins of a type known as “Nanobodies™” are relatively simple proteins and are much smaller than traditional antibodies, about one tenth the size of human antibodies and having a length measured in nanometers, for example from about 1 to about 7 or from about 1 to about 3 nanometers in length although not limited to these ranges. Nanobodies™ are more resistant to heat and pH than traditional antibodies. Nanobodies™ are also hydrophilic; a characteristic that the present system and process employs to attach the Nanobodies™ to a charged substrate.

The present disclosure is directed to an imaging system comprising a monoclonal nanobody coated on at least a portion of an image receiving substrate; at least one antigen dye that will bind to the monoclonal nanobody coated portion of the receiving substrate upon exposure to light; wherein an image projected onto the monoclonal nanobody coated substrate is recorded in the antigen dye particles that bind to the monoclonal antibody coated portion of the substrate.

The imaging system disclosed herein is based on use of monoclonal Nanobodies™ and antigens. Monoclonal antibody proteins of the type known as Nanobodies™ will specifically bind to almost any given substance (an “antigen”). The imaging system herein employs monoclonal antibodies designed to bind to antigen dyes upon exposure to light. Once an antibody has bound to a dye particle, it cannot rebind again.

In embodiments, the present imaging process comprises projecting an image onto a substrate coated with hydrophilic monoclonal antibodies, e.g. Nanobodies™, on at least a portion thereof; and recording the projected image in antigen dye particles that bind to the antibodies coating the substrate.

Any suitable or desired antigen dye can be used in the present system and process. One or a plurality of antigen dyes can be selected to provide one or more colors such as cyan, magenta, yellow, and black, alone or in combination. For example, antigen dyes can be selected to provide only the primary colorants cyan, magenta and yellow, with black being rendered by a combination of the cyan, magenta and yellow colorants. In embodiments, the antigen dye selected is a plurality of antigen dyes providing an image possessing a full color gamut.

In a specific embodiment, light-activated rhodopsin is selected for the antigen dye. Upon exposure to light, dark-adapted rhodopsin protein changes its structure to that recognized by the monoclonal antibodies used in this system. In further embodiments, other light-sensitive proteins (such as the human photopsin proteins) can be employed as the antigen dye.

Rhodopsin can be obtained commercially and is very stable. For example, fresh bovine retinae can be acquired from W. L. Lawson (Lincoln, NE). Rhodopsin can be synthesized by any desired or suitable method. Rhodopsin can be synthesized by the oxidation of vitamin A₁ to retinene₁ by the retinene reductase system, coupled with the condensation of retinene₁ with opsin to form rhodopsin. For further detail see, for example, Ruth Hubbard and George Wald, “The Mechanism of Rhodopsin Synthesis,” Proceedings of the National Academy of Sciences, Vol. 37, No. 2, February 15, 1951, pages 69-79, which is hereby incorporated by reference herein in its entirety.

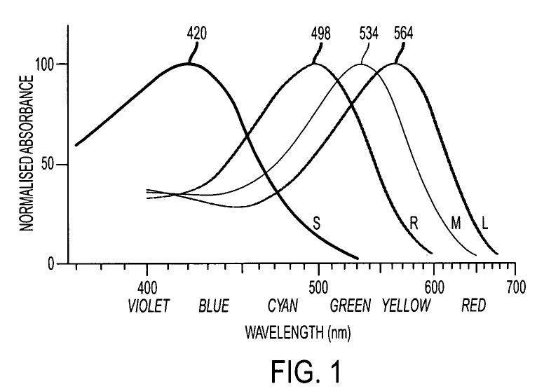

Turning to FIG. 1, a graph illustrating normalized absorbance (y-axis) versus wavelength (x-axis, nanometers) for various proteins designated S, R, M and L is provided. See http://en.wikipedia.org/wiki/Photopsin, which is hereby incorporated by reference herein in its entirety. Rhodopsin's response to light, indicated by curve R in FIG. 1, is strongest to green-blue, while human photopsin I, indicated by cur L in FIG. 1, photopsin II, indicated by curve M in FIG. 1, and photopsin III, indicated by curve S in FIG. 1, each exhibit different frequencies of maximum sensitivity. This range of response is employed in the present system and process to create full-color images. Through use of human rhodopsin dyes, the present system and process is contemplated to encompass production of images having the full color gamut of the human eye.

In embodiments, the Nanobodies™ are designed to bind with light sensitive dyes, for example, rhodopsin, after the dye has been activated by exposure to light of the appropriate wavelength. The dyes can be carried in an aqueous solution that bathes the positively charged receptor surface carrying the Nanobodies™.

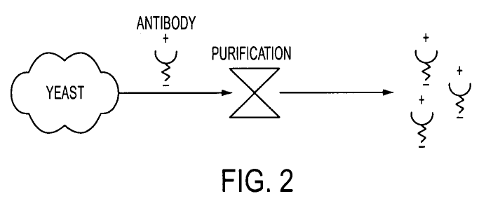

Monoclonal antibodies used herein can be prepared by any desired or suitable method. FIG. 2 illustrates schematically the preparation of monoclonal antibodies from genetically modified bacteria, yeasts, or fungi (indicated in FIG. 2 as yeast), followed by purification. The ability to manufacture monoclonal Nanobodies™ by bacteria, yeast or fungi renders them less expensive than traditional antibodies which require mouse or hamster cells for synthesis. See, for example, U.S. Pat. No. 6,838,254, which is hereby incorporated by reference herein in its entirety, describing production of antibodies or (functionalized) fragments thereof derived from heavy chain immunoglobulins of Camelidae by lower eukaryotes such as yeasts and fungi. See also U. S. Pat. No. 6,765,087, which is hereby incorporated by reference herein in its entirety, describing in embodiments immunoglobulins devoid of light polypeptide chains obtained from prokaryotic cells, such as E. coli cells. Nanobodies™ can be obtained from VIB Nanobody Service Facility, Brussel, Belgium. Nanobodies® can also be obtained from Ablynx, Ghent, Belgium. See, “Nanobodies,” Scientific American Magazine, Jul. 25, 2005, http://www.sciam.com/article.cfm?id=nanobodies&print=true, pages 1-4, which is hereby incorporated by reference herein.

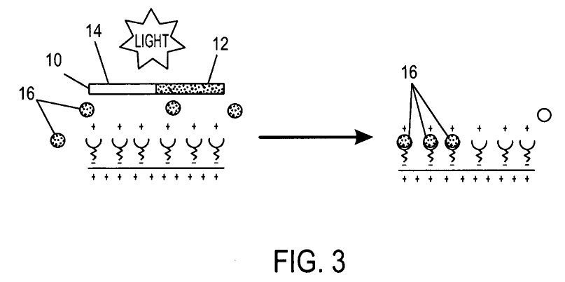

The hydrophilic antibodies produced are polar, with a negative electrical charge at one end indicated by the negative sign and a positive charge at the other, binding site, end indicated by a plus sign. When applied to a substrate with a positive charge, the negatively charged end of the antibodies will automatically attach to the substrate, leaving the positively charged binding site end exposed as shown in FIG. 3.

The monoclonal Nanobodies™ can be applied to the substrate by any desired or suitable method. Any suitable technique may be employed to mix and thereafter apply the monoclonal nanobody with typical application techniques including, but not being limited to, spraying, dip coating, roll coating, wire wound rod coating, and the like. Drying, as for other layers if present, can be effected by any suitable technique, such as, but not limited to, oven drying, infrared radiation drying, air drying, and the like.

Any suitable substrate can be employed herein. Substrates suitable for use herein are those having a charge or being chargeable such that the nanobodies attach to the substrate in a manner which leaves the dye binding site exposed. In embodiments, the substrate is a positively charged substrate or a positively chargeable substrate. Many plastics exhibit the property of having an electrical charge and such plastics can be used in embodiments herein. In embodiments, the substrate can comprise a positively charged polymer such as chitosan. Further examples of substrates include, but are not limited to, positively charging members of the triboelectric series such as glass, nylon, wool, silk aluminum and paper. In embodiments, the substrate comprises a sulfonated tetrafluoroethylene copolymer, such as Nafion® available from DuPont™. In embodiments, the substrate can comprise paper, the paper having disposed on all or a portion thereon a coating comprising the nanobodies.

An adhesive layer may optionally be applied such as to attach the nanobody coated substrate to a base layer on which the nanobody coated substrate can optionally be disposed. The adhesive layer may comprise any suitable material, for example, any suitable film forming polymer. Typical adhesive layer materials include, but are not limited to, for example, copolyester resins, polyarylates, polyurethanes, blends of resins, and the like. Any suitable solvent may be selected in embodiments to form an adhesive layer coating solution. Typical solvents include, but are not limited to, for example, tetrahydrofuran, toluene, hexane, cyclohexane, cyclohexanone, methylene chloride, 1,1,2-trichloroethane, monochlorobenzene, and mixtures thereof, and the like.

The layers herein can be of any desired or suitable thickness. The thickness of the imaging device typically ranges from about 2 μm to about 100 μm; from about 5 μm to about 50 μm, or from about 10 μm to about 30 μm. The thickness of each layer will depend on how many components are contained in that layer, how much of each component is desired in the layer, and other factors familiar to those in the art. The nanobody coating layer may, in embodiments, be about 10 nanometers in thickness, although not limited.

Although not wishing to be bound by theory, the rhodopsin protein has two stable structural states. See R. E. Stenkamp et al., “Crystal Structure of Rhodopsin: A G-Protein Coupled Receptor,” Chem Bio Chem 2002, 3, pages 963-967, Wiley-VCH, which is hereby incorporated by reference herein. Upon absorption of a photon, the protein changes from its rhodopsin ground state to the active metarhodopsin state. When the antibody-coated substrate is exposed to light in the presence of the antigen dye, the dye particle's protein structure changes to one that will bind to the antibody's binding site. See Brian W. Bailey, et al., “Constraints on the conformation of the cytoplasmic face of dark-adapted and light-excited rhodopsin inferred from antirhodopsin antibody imprints,” Protein Science, 2003, 12, pages 2453-2475, which is hereby incorporated by reference herein, for further detail on photo-mediated biological processes.

When the antibody-coated substrate is exposed to light in the presence of the antigen dye, the dye particle's protein structure will change to a structure that will bind to the antibody's binding site. In those parts of the substrate that are not exposed to light, no dye particles will be bound, thereby recording an image. This is illustrated schematically in the example of FIG. 3. FIG. 3 illustrates the application of light through an image transparency 10 consisting of an opaque (black) half 12 and a transparent (white) half 14, with unbound dye particles (black spots) 16 present. Following exposure to light, the antigen dye particles 16 that were illuminated have bound to the antibodies closest to them, producing a negative image.

Further embodiments encompassed within the present disclosure include methods of imaging and printing with the imaging system illustrated herein. Various exemplary embodiments include methods including forming an electrostatic latent image on an imaging member; developing the image with at least one antigen dye, optionally at least one charge additive, and optionally at least one surface additive; transferring the image to a necessary member, such as, for example any suitable substrate, and permanently affixing the image thereto via antigen dye-nanobody binding. In various exemplary embodiments in which the embodiment is used in a printing mode, various exemplary imaging methods include forming an electrostatic latent image on an imaging member by use of a laser device or image bar; developing the image with at least one antigen dye, optionally, at least one charge additive, and optionally, at least one surface additive; transferring the image to a necessary member, such as, for example any suitable substrate, and permanently affixing the image thereto via antigen-nanobody binding.

In a selected embodiment, an image forming apparatus for forming images on a recording medium comprises a) a photoreceptor member having a monoclonal antibody coated substrate, in embodiments a monoclonal nanobody coated substrate, to receive antigen dye particles that will bind to the monoclonal antibody coated portion of the receiving substrate upon exposure to light; b) a light source for projecting an image on to the monoclonal nanobody coated substrate; wherein the image projected onto the monoclonal antibody coated substrate is recorded in the antigen dye particles that bind to the monoclonal antibody coated portion of the substrate.

Advantageously, the proteins employed in the system and process herein are smaller than the wavelength of blue light and enable high photographic resolution. In a further advantage, the present system and method provides a radically new material set for a type of photography. Further, the biological materials employed herein are inexpensive and simple to produce once the initial genetic engineering is completed. The antibodies and their matching antigens can be patented and readily detected, eliminating third-party reverse-engineering and competition to deliver supplies to the market place. The photoreceptive material's resolution is inherently very high, reproducing extremely fine detail. A wide array of materials can be coated with antigen, including metals, in embodiments, precious metals including gold, silver, platinum, or palladium, noble metals including tantalum, gold, platinum and rhodium, or other materials, to produce printable dyes having properties not currently available. In embodiments, the antigen dye can comprise one or more metals coated with one or more antigen dyes.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. An imaging system comprising:
a substrate;
a hydrophilic monoclonal antibody coated on at least a portion of the substrate;
at least one antigen dye that will bind to the monoclonal antibody coated portion of the receiving substrate upon exposure to light;
wherein an image projected onto the monoclonal antibody coated substrate is recorded in the antigen dye particles that bind to the monoclonal antibody coated portion of the substrate.

2. The imaging system of claim 1, wherein the substrate is a positively charged substrate or a positively chargeable substrate.

3. The imaging system of claim 1, wherein the substrate is a positively charged polymer.

4. The imaging system of claim 3, wherein the substrate is chitosan.

5. The imaging system of claim 3, wherein the substrate is a glass, nylon, wool, silk, aluminum, or paper.

6. The imaging system of claim 3, wherein the substrate is a sulfonated tetrafluoroethylene copolymer.

7. The imaging system of claim 1, wherein the monoclonal antibody is a nanobody.

8. The imaging system of claim 1, wherein the monoclonal nanobody is polar, having a negative electrical charge at a first end and having a positive electrical charge at a second, opposite end.

9. The imaging system of claim 1, wherein the antigen dye is a plurality of antigen dyes providing an image possessing a full color gamut.

10. The imaging system of claim 1, wherein the antigen dye particle is rhodopsin.

11. The imaging system of claim 1, wherein the antigen dye particle is human photopsin I, photopsin II, photopsin III, or a combination thereof.

12. The imaging system of claim 1, wherein the antigen dye is a metal coated with antigen dye.

13. The imaging system of claim 1, wherein the antigen dye is gold, silver, platinum, palladium, tantalum, or rhodium coated with antigen dye.

14. An imaging process comprising:
projecting an image onto a positively charged substrate having exposed hydrophilic monoclonal antibodies disposed on at least a portion of the substrate;
disposing at least one antigen dye thereover such that the one or more antigen dyes bind to the exposed portion of the antibody-coated substrate thereby recording the projected image via antigen dye particles bound to the exposed antibodies.

15. The process of claim 14, wherein projecting an imagine comprises providing an image transparency comprising one or more opaque portions and one or more transparent portions defining the image; and
exposing the antibody-coated substrate to light thereby recording an image comprising the transparent portions of the transparency.

16. The process of claim 14, wherein the substrate is a positively charged substrate or a positively chargeable substrate.

17. The imaging system of claim 14, wherein the substrate is chitosan.

18. The process of claim 14, wherein the substrate is a sulfonated tetrafluoroethylene copolymer.

19. The process of claim 14, wherein the monoclonal antibody is a nanobody.

20. The process of claim 14, wherein the antigen dye is a plurality of antigen dyes providing an image possessing a full color gamut.

21. The process of claim 14, wherein the antigen dye particles is rhodopsin.

22. The process of claim 14, wherein the antigen dye particle is human photopsin I, photopsin II, photopsin III, or a combination thereof.

23. The process of claim 14, wherein the antigen dye is a metal coated with antigen dye.

24. The process of claim 14, wherein the antigen dye is gold, silver, platinum, palladium, tantalum, or rhodium coated with antigen dye.
